(19) United States
(12) Patent Application Publication
(10) Pub. No.: US 2025/0093913 A1
(43) Pub. Date: Mar. 20, 2025

(54) MULTI-CONFIGURATION LED DISPLAY SIMULATOR SYSTEM AND METHOD(S) OF USE

(71) Applicant: Ti Training, LLC, Golden, CO (US)

(72) Inventors: Gregory Otte, Lakewood, CO (US); Todd R. Brown, Lakewood, CO (US); William Otte, Golden, CO (US)

(21) Appl. No.: 18/950,125

(22) Filed: Nov. 17, 2024

Related U.S. Application Data
(60) Provisional application No. 63/583,514, filed on Sep. 18, 2023.
(60) Provisional application No. 63/672,575, filed on Jul. 17, 2024.

(51) Int. Cl. G06F 1/16

(52) U.S. Cl. CPC G06F 1/1649; G06F 1/1681; G06F 1/1686

(57) ABSTRACT

A multi-configuration LED display simulator system and method(s) of use is described. Embodiments of the multi-configuration LED display simulator system can implement an LED display assembly utilizing a mounting system configured to allow LED panels to safely rotate relative to one another.

### CROSS-REFERENCE TO RELATED APPLICATION

This application claims the benefit of U.S. Provisional Application No. 63/583,514, filed on Sep. 18, 2023 and U.S. Provisional Application No. 63/672,575, filed on Jul. 17, 2024.

### BACKGROUND

Conducted electrical weapons (CEWs) and firearms are used by police officers and civilians alike. Proper training and handling are paramount to successfully using a CEW both effectively and safely. Further, proper training and handling are paramount to successfully using a firearm both effectively and safely. Since a CEW and firearm are each intended to be used sparingly, it is difficult to train with a CEW or firearm without firing expensive cartridges and ammunition.

Currently available training systems are limited to displays needed to be located in low-light locations due to several technical issues arising well-lit areas. LED displays provide sufficient brightness for well-lit areas, however, this causes several problems for the detection of infra-red signals on the LED displays. Further, LED panels are generally made from non-flexible material. As such, panels of displays located proximate another display would not allow for a rotation of a panel without damaging one or more panels.

A means for simulating firing a CEW and/or firearm in well-lit areas is needed. More specifically, a system for practicing with a CEW and/or firearm in a simulated environment is needed that implements various training models and methods.

### BRIEF DESCRIPTION OF THE DRAWINGS

FIG. 1 is a block diagram of a multi-configuration LED display simulator system according to one embodiment of the present invention.

FIG. 2A is a top view of a multi-configuration LED display assembly according to one embodiment of the present invention.

FIG. 2B is a top view of a multi-configuration LED display assembly according to one embodiment of the present invention.

FIG. 3 is a back view of a mounting system for a multi-configuration LED display assembly according to one embodiment of the present invention.

FIG. 4A is a close-up top view of a mounting system for a multi-configuration LED display assembly according to one embodiment of the present invention.

FIG. 4B is a close-up back view of a mounting system for a multi-configuration LED display assembly according to one embodiment of the present invention.

FIG. 4C is a close-up top view of a mounting system including separated LED displays for a multi-configuration LED display assembly according to one embodiment of the present invention.

FIG. 4D is a close-up back view of a mounting system including separated LED displays for a multi-configuration LED display assembly according to one embodiment of the present invention.

### DETAILED DESCRIPTION

Embodiments of a present invention include a multi-configuration LED display simulator system and method(s) of use and a mounting system for the multi-configuration LED display simulator system. The mounting system can be implemented to allow a first LED display to be rotated in relation to a second LED display. In some instances, a third LED display can be rotated in relation to the second LED display.

The multi-configuration LED display simulator system can include, but is not limited to, a multi-configuration LED display assembly and a simulator system. Typically, the simulator system can be implemented to run a simulated training scenario and the multi-configuration LED display assembly can be implemented to display the simulated scenario.

The mounting system can be implemented to provide a substantially seamless gap between LED displays mounted to different mounting assemblies. Embodiments of the mounting system can include a hinge assembly mounted between displays that can be slid apart, allowing a display to rotate in relation to another display, and then sliding the displays back together when a desired angle is achieved.

In one embodiment, the multi-configuration LED display assembly can include, but is not limited to, a first LED display, a second LED display, a third LED display, and a boom adapted to couple proximate a top of each of the displays. The first LED display can include a plurality of LED panels operatively coupled together. The second LED display can include a plurality of LED panels operatively coupled together. The third LED display can include a plurality of LED panels operatively coupled together. The simulator system can include, but is not limited to, a control module, one or more simulated weapons, and a plurality of cameras. The plurality of cameras can be implemented to detect pulses of light generated by the simulated weapons. The first LED display, the second LED display, and the third LED display can be implemented to display one or more training scenarios.

Typically, the first LED display can be a static display that is located between the second LED display and the third LED display. The second LED display and the third LED display can each be rotatably coupled to the first LED display.

In a typical implementation, a camera can be mounted to a distal end of a boom coupled to each of the LED displays. For instance, the boom can be located proximate an upper portion of each of the LED displays and extend out from the LED displays where a mount can be located. The mount can be implemented to couple the camera to the boom. As can be appreciated, the multi-configuration LED display assembly can be constantly reconfigured without having to move the cameras separately after the LED screens have been moved. In some embodiments, simulations can take place where the multi-configuration LED display assembly can be reconfigured in conjunction with the simulated training scenario. In other instances, the multi-configuration LED display assembly can be configured to provide three independent screens allowing multiple users to interact with individualized training scenarios.

Generally, the first LED display can have a hinged connection to the second LED display on one side and a hinged connection to the third LED display on the other side. As can be appreciated, the second LED display and the third LED display can move (or rotate) relative to the static LED display providing a plurality of different configurations.

Embodiments of the present invention include novel methods of implementing LED displays with a simulator system that uses infrared camera detection to detect hits and misses from an IR laser. In one method, described in more detail hereinafter, a means for auto-dimming a portion of the LED displays can be implemented to aid in shot detection. In a second method, described in more detail hereinafter, a means for adjusting color saturation of a portion of the LED displays can be implemented to aid in shot detection. In a third method, described in more detail hereinafter, a means for boosting a gain of images captured by the camera to aid in shot detection.

Of note, LED panels have a low reflectivity on a surface of the LED panel for infra-red laser beams. At angles of more than 40 degrees from centerline, a brightness of a laser spot can be too low to be detected on an LED panel. As can be appreciated, this can produce corner and edge blindness in detecting an IR laser on an LED panel by a shot detection system. Of note, camera sensor size, resolution, and frame rate are all factors that can limit a “viewable” area of a camera. System implementing projectors allow for looser parameters in detection of IR lasers, whereas LED Panels require a tighter and more limited view.

A calibration system of the simulator system can be configured to accommodate an optional configuration of a single wide screen with three tracking cameras. A single wide screen image can be displayed by the first LED display, the second LED display, and the third LED display to eliminate three video processors. As can be appreciated, by implementing a single video processor the three LED display, the simulator system can function as a dual-purpose command center. The calibration system can be further configured to detect a restricted area-of-interest (AOI) in a camera frame more reliably. Of note, for systems implementing projectors, a seam or edge of vinyl screens can be used to define the AOI. However, since the LED displays have a sharp edge, the AOI can be harder to define. The calibration system can designate a restricted AOI.

A configuration system of the simulator system can be configured to include a user-specified camera gain to be used during shot tracking. Of note, an intensity of the light from the LED would greatly distort the LED from the IR lasers emitted by a training device. In one example, an intensity in the gain of a camera can be pushed to a maximum level (e.g., 500-556 of an acA800-200 gm Basler camera). As can be appreciated, this can allow the camera to visibly see IR lasers more defined against the LED diodes.

The configuration system can be further configured to include a user-specified count of minimum bright pixels to be considered as a valid laser mark on the display. The minimum bright pixel acceptance margin varies from systems implementing projectors due to an angle at which an IR laser hits the LED display and reflecting less of the light back towards the camera. Of note, a detection of an IR laser can also be affected by the color/lighting of an image currently being displayed. A white (or bright) image can have all or more LED diodes activated and thus blocking some of the IR laser out. A black (or dark) image has none or less of the LED diodes activated allowing more of the IR laser to be reflected. The LED configuration system can be configured to accept a pixel brightness range of 2-10 pixels.

A tracking system of the simulator system can be configured to take raw images from the camera and convert the detected laser into X, Y coordinates. The coordinates can be sent to the various applications with a timestamp. The tracking system can be configured to use a boost to the camera gain feature while tracking laser shots. In one instance, the gain boosts a level of light seen through a camera lens in a circular gradient outwards from a central point. As can be appreciated, the gain can brighten an image closer to the corners of the screen. Of significant note, the gain is not used during calibration of the simulator system.

The tracking system can be further configured to use a count of minimum bright pixels to be considered as a valid laser mark on the LED display. The tracking system can accept the minimum pixel value set in the configuration system.

A tracker adapter can be configured to accommodate an optional configuration of a single wide screen with three tracking cameras. The simulator system can be configured to accept settings in the calibration system and the configuration system. The two systems both provide the necessary coordinates and information to a training program to properly place the “shot” on the correct coordinate on the displayed content. These coordinates are dependent on the resolution of the screen to properly indicate what object may be “hit” during a training scenario.

A method of configuring a multi-configuration LED display assembly can include, but is not limited to, the steps of: (i) providing a mounting system; (ii) providing a simulator system; and (iii) configuring the second frame assembly in relation to the first screen assembly. The mounting system can include, but is not limited to, a first frame assembly, a second frame assembly, a third frame assembly, a first hinge assembly, and a second hinge assembly. The first frame assembly can be coupled to and support a first set LED panels. The second frame assembly can be coupled to and support a second set of LED panels. The third frame assembly can be coupled to and support a third set of LED panels. The first hinge assembly can hingeably couple the second frame assembly to the first frame assembly. The first hinge assembly can be defined by (i) a first hinge member, (ii) a first member extending from the first hinge member in a first direction and slidably coupled to the first frame assembly, and (iii) a second member extending from the first hinge member in a second direction and slidably coupled to the second frame assembly. The second hinge assembly can hingeably couple the third frame assembly to the first frame assembly. The second hinge assembly can be defined by (i) a second hinge member, (ii) a third member extending from the second hinge member in a first direction and slidably coupled to the first frame assembly, and (iii) a fourth member extending from the second hinge member in a second direction and slidably coupled to the third frame assembly. The simulator system can be operatively connected to the first set of LED panels, the second set of LED panels, and the third set of LED panels. The second frame assembly can be configured in relation to the first screen assembly by: (i) separating the second frame assembly from the first frame assembly via the first hinge assembly; (ii) rotating the second frame assembly in relation to the first frame assembly; and (iii) pushing the second frame assembly back towards the first frame assembly.

The second frame assembly can be separated from the first frame assembly by sliding (i) the first member away from the first frame assembly, and (ii) the second member from the third frame assembly. The method can further include the step of configuring the third frame assembly in relation to the first screen assembly by: (i) separating the third frame assembly from the first frame assembly via the second hinge assembly; (ii) rotating the third frame assembly in relation to the first frame assembly; and (iii) pushing the third frame assembly back towards the first frame assembly. The third frame assembly can be separated from the first frame assembly by sliding (i) the third member away from the first frame assembly, and (ii) the fourth member from the third frame assembly. The first frame assembly further includes a boom coupled proximate a top of the first frame assembly, the boom extending out from the first set of LED panels with a camera coupled to a distal end of the boom. The second frame assembly can further include a boom coupled proximate a top of the second frame assembly, the boom extending out from the second set of LED panels with a camera coupled to a distal end of the boom. The third frame assembly can further include a boom coupled proximate a top of the third frame assembly, the boom extending out from the third set of LED panels with a camera coupled to a distal end of the boom. In one instance, the camera can have a 96-degree field of view. The camera can be operatively connected to the simulator system.

One or more components of the present invention can be embodied as devices, systems, methods, and/or computer program products. Accordingly, the present invention can be embodied in hardware and/or in software (including firmware, resident software, micro-code, etc.). Furthermore, the present invention can take the form of a computer program product on a computer-usable or computer-readable storage medium having computer-usable or computer-readable program code embodied in the medium for use by or in connection with an instruction execution system. In one embodiment, the present invention can be embodied as non-transitory computer-readable media. In the context of this document, a computer-usable or computer-readable medium can include, but is not limited to, any medium that can contain, store, communicate, propagate, or transport the program for use by or in connection with the instruction execution system, apparatus, or device.

The computer-usable or computer-readable medium can be, but is not limited to, an electronic, magnetic, optical, electromagnetic, infrared, or semiconductor system, apparatus, device, or propagation medium.

### Terminology

The terms and phrases as indicated in quotation marks (“ ”) in this section are intended to have the meaning ascribed to them in this Terminology section applied to them throughout this document, including in the claims, unless clearly indicated otherwise in context. Further, as applicable, the stated definitions are to apply, regardless of the word or phrase's case, to the singular and plural variations of the defined word or phrase.

The term “or” as used in this specification and the appended claims is not meant to be exclusive; rather the term is inclusive, meaning either or both.

References in the specification to “one embodiment”, “an embodiment”, “another embodiment, “a preferred embodiment”, “an alternative embodiment”, “one variation”, “a variation” and similar phrases mean that a particular feature, structure, or characteristic described in connection with the embodiment or variation, is included in at least an embodiment or variation of the invention. The phrase “in one embodiment”, “in one variation” or similar phrases, as used in various places in the specification, are not necessarily meant to refer to the same embodiment or the same variation.

The term “couple” or “coupled” as used in this specification and appended claims refers to an indirect or direct physical connection between the identified elements, components, or objects. Often the manner of the coupling will be related specifically to the manner in which the two coupled elements interact.

The term “directly coupled” or “coupled directly,” as used in this specification and appended claims, refers to a physical connection between identified elements, components, or objects, in which no other element, component, or object resides between those identified as being directly coupled.

The term “approximately,” as used in this specification and appended claims, refers to plus or minus 10% of the value given.

The term “about,” as used in this specification and appended claims, refers to plus or minus 20% of the value given.

The terms “generally” and “substantially,” as used in this specification and appended claims, mean mostly, or for the most part.

Directional and/or relationary terms such as, but not limited to, left, right, nadir, apex, top, bottom, vertical, horizontal, back, front and lateral are relative to each other and are dependent on the specific orientation of a applicable element or article, and are used accordingly to aid in the description of the various embodiments and are not necessarily intended to be construed as limiting.

The term “software,” as used in this specification and the appended claims, refers to programs, procedures, rules, instructions, and any associated documentation pertaining to the operation of a system.

The term “firmware,” as used in this specification and the appended claims, refers to computer programs, procedures, rules, instructions, and any associated documentation contained permanently in a hardware device and can also be flashware.

The term “hardware,” as used in this specification and the appended claims, refers to the physical, electrical, and mechanical parts of a system.

The terms “computer-usable medium” or “computer-readable medium,” as used in this specification and the appended claims, refers to any medium that can contain, store, communicate, propagate, or transport the program for use by or in connection with the instruction execution system, apparatus, or device. The computer-usable or computer-readable medium may be, for example but not limited to, an electronic, magnetic, optical, electromagnetic, infrared, or semiconductor system, apparatus, device, or propagation medium. By way of example, and not limitation, computer readable media may comprise computer storage media and communication media.

The term “signal,” as used in this specification and the appended claims, refers to a signal that has one or more of its characteristics set or changed in such a manner as to encode information in the signal. It is to be appreciated that wireless means of sending signals can be implemented including, but not limited to, Bluetooth, Wi-Fi, acoustic, RF, infrared and other wireless means.

### An Embodiment of a Multi-Configuration LED Display Simulator System

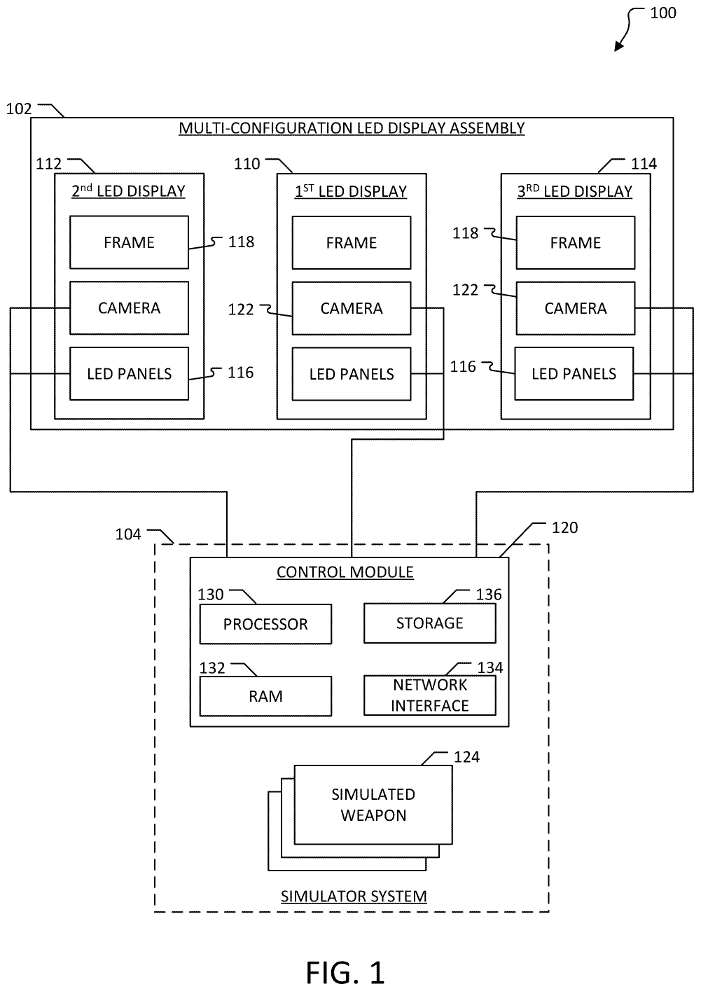

Referring to FIG. 1, a block diagram of an embodiment 100 of a multi-configuration LED display simulator system is illustrated. The multi-configuration LED display simulator system 100 can be implemented to provide a plurality of simulator training configurations from individual use life size screens to a single large screen.

As shown in FIG. 1, the multi-configuration LED display simulator system 100 can include, but is not limited to, a multi-configuration LED display assembly 102 and a simulator system 104. The multi-configuration LED display assembly 102 can be implemented to display one or more training scenarios being run by the simulator system 104.

The multi-configuration LED display assembly 102 can include, but is not limited to, a first LED display 110, a second LED display 112, and a third LED display 114. Each of the LED displays can be configured from a plurality of LED panels 116 coupled to a plurality of frames 118 operatively connected together. As will be discussed further hereinafter, the first LED display 110 can be implemented as a static display, the second LED display 112 can be implemented as a first rotatable (or moveable) display, and the third LED display 114 can be implemented as a second rotatable (or moveable) display. Typically, each of the LED displays can be coupled together to form one configurable LED display assembly. The LED displays may collectively display a single training scenario. In another instance, the LED displays may each individually display a different training scenario.

The simulator system 104 can include, but is not limited to, a control module 120, a plurality of cameras 122, and one or more simulated weapons 124. The control module 120 can be implemented to run one or more training scenarios. The plurality of cameras 122 can be implemented to detect pulses of light generated by the simulated weapons 124.

Typically, the control module 120 can be any type of computing device including, but not limited to, a personal computer, a server, a game console, a smartphone, a tablet, a netbook computer, or other computing devices. In one embodiment, the control module 120 can be a distributed system wherein computing functions are distributed over several computers connected to a network. The control module 120 can typically have a hardware platform and software components.

The control module 120 can generally include a processor 130, random access memory 132, a network interface 134, and a nonvolatile storage (or memory) 136. The processor 130 can be a single microprocessor, multi-core processor, or a group of processors. The random access memory 132 can store executable code as well as data that may be immediately accessible to the processor 130, while the nonvolatile storage 136 can store executable code and data in a persistent state. The network interface 134 can include hardwired and wireless interfaces through which the control module 120 can communicate with other devices and/or networks. In some embodiments, more than one control module 120 can be implemented. For instance, a control module can be operatively coupled to each of the cameras and the LED displays.

The control module 120 can be adapted to store and play training scenarios. Typically, the control module 120 can be configured to run a program or application which can decipher signals generated by the simulated weapons 124 and detected by one of the cameras 122. For instance, the cameras 122 can be configured to detect pulses of light from lasers integrated with or combined with the simulated weapons 124. In some instances, the lasers can be retroactively fitted to real weapons to simulate firing a live weapon.

The cameras 122 can be operatively connected to the control module 120. For instance, the control module 120 can run a training scenario which can be displayed by the LED displays. In one embodiment, the control module 120 can sync a training scenario to be displayed by each of the LED displays. The cameras 122 can be implemented to detect pulses of light generated from one of the simulated weapons 124. In one example, three cameras 122 can be mounted on booms at the top of the frames 118. The cameras 122 can be located approximately 8 feet from a surface of the LED displays. Typically, each camera can implement a 96-degree field of view to cover an assigned section of the LED displays.

Of note, the control module 120 can be configured to determine if a detected pulse of light from each of the cameras 122 hit a target. For instance, the control module 120 can determine if a pulse of light hit an intended target on the multi-configuration LED display assembly based on receiving a signal from one of the cameras 122. Typically, the control module 120 can associate a particular LED display with an associated camera. As can be appreciated, where the multi-configuration LED display assembly is set up for individual displays, the control module 120 can be configured to differentiate between pulses of light detected by the cameras 122 on each LED display.

In embodiments with more than one control module 120, each of the control modules can be configured to display synchronized training scenarios on the multi-configuration LED display assembly. Of note, and as discussed later, when the multi-configuration LED display assembly is set up to be three independent screens, multiple control modules can be implemented to run independent scenarios on each of the screens. Alternatively, a single control module can be configured to run independent training scenarios on each of the LED displays.

The simulated weapon 124 can typically include as least one laser. The at least one laser can be adapted to generate a pulse of light with a wavelength in the infrared spectrum in response to a trigger of the simulated weapon 124 being pulled. For instance, the at least one laser can generate a pulse of light with a wavelength of 785 nm plus or minus 50 nm. Typically, lasers adapted to generate pulses of light not visible to a human are implemented including, but not limited to, infrared spectrum lasers. It is to be appreciated that other means of generating waves in the non-visible light spectrum can be implemented without exceeding the scope of the present invention. The cameras 122 can be configured to detect the pulse of light generated by the at least one laser.

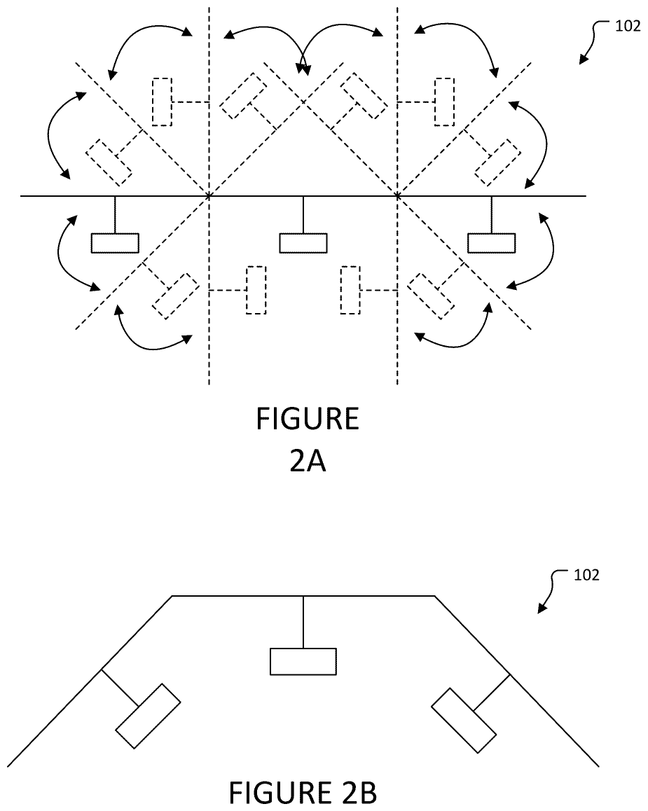

Referring generally to FIGS. 2A-2B, a top view of a multi-configuration LED display assembly 102 with cameras 122 is illustrated. As illustrated in FIG. 2B, the first rotatable LED display and the second rotatable LED display can rotate about 45 degrees from being in-line with the static LED display to provide an approximately 180 degree viewing surface for a user located near the multi-configuration LED display assembly. As is shown in FIG. 2A, the first rotatable LED display and the second rotatable LED display can rotate forwards and backwards to provide a plurality of different configurations for the multi-configuration LED display assembly.

The cameras 122 can be located above and away from the LED displays to allow for shot detection on an entirety of the LED displays. Typically, a boom can be implemented to extend out from each of the LED displays. Each of the booms can include a means for coupling the camera 122 to a distal end of the boom. Generally, the boom can be located proximate a top of each of the LED displays. The boom can extend out from a top of the LED displays such that the cameras 122 can be above the top of the LED displays. In one embodiment, the boom can be configured to be telescoping.

As can be appreciated, once the cameras 122 have been calibrated with the LED displays, the camera will not need to be recalibrated when the multi-configuration LED display assembly is reconfigured to a different layout. Of note, when one of the rotatable LED displays move, the camera connected to the moving LED display can move with the LED display.

As will be described in more detail hereinafter, a plurality of hinged connections (or hinge assemblies) can be implemented to couple the second LED display to the first LED display and the third LED display to the first LED display. As can be appreciated, other connection types and means or couplings are contemplated that allow the second LED display and the third LED display to rotate in relation to the first LED display.

The multi-configuration LED display assembly 102 can be configured to provide a variety of different screen layouts depending on a scenario being run by the simulator system 104. In one embodiment, the rotatable LED displays located on either side of the static LED display can be adapted to rotate approximately 360 degrees from a hinged connection between sides of the LED displays. By having the cameras 122 connected to the LED displays via the booms, the multi-configuration LED display assembly can allow for numerous configurations between the LED displays without having to move and recalibrate each camera each time the screen assembly is reconfigured.

### Methods of Implementing a Training Scenario by a Multi-Configuration LED Display Simulator System

Methods of implementing a training scenario that can be displayed via an LED display are described hereinafter. Of note, due to the brightness of an LED display, light in the infrared spectrum can be generated by the LED displays. The one or more methods can be implemented to better aid a sensor of a simulator system to detect a pulse of infrared light generated by a simulated weapon. The simulator system may include a plurality of training scenarios adapted to test each function of a simulated weapon. The training scenario can follow a plurality of different paths depending on how a user interacts with the simulated weapon. For instance, the training scenario can branch multiple ways depending on whether the user pulls a trigger or does not react soon enough. If the situation calls for the user to pull the trigger and fire at a perpetrator, and if the simulator system determines the shot hit the perpetrator, the training scenario can branch to a video of the perpetrator being taken down.

In a first example method (or process), a training scenario can be run on the multi-configuration LED display simulator system 100 using the LED displays to display the training scenario. Of note, the training scenario can be used to train a user in proper firearm use (or other weapon) by presenting scenarios for the user to interact with using the simulated weapon 124. Typically, the simulated weapon 124 can implement an IR laser to generate a pulse of light from which the simulator system 104 can detect the pulse of light on the LED display assembly 102.

In a first step, the control module 120 can initiate the training scenario to be played and displayed via the LED display assembly 102.

In a second step, the control module 120 can increase a gain of each of the cameras 122 during shot tracking. The increase in gain can boost a level of light seen through a camera lens in a circular gradient outwards from a central point. As can be appreciated, the gain can brighten an image closer to the corners of the screen. Of significant note, the gain is not used during calibration of the simulator system 104.

In a third step, the control module 120 can determine when a shot is detected and determine if the shot hit a target.

In a fourth step, the control module 120 can branch the training scenario based on determining if the detected shot hit a target or not.

In a second example method (or process), the control module 120 can be configured to dim (e.g., reduce a brightness) one or more LED panels 116 of the LED display assembly 102 where a target may be located. Generally, an LED panel including at least a portion of a target may be dimmed. Of note, the control module 120 can be configured to send a signal to each LED panel to be dimmed while the target is present on said LED panel. Once the target is gone from an LED panel, the control module 120 can send a signal for the LED panel to go back to full brightness.

In a first step, the control module 120 can initiate the training scenario to be played and displayed via the LED display assembly 102.

In a second, decision, step, the control module 120 can continuously determine if a target is located in a frame of the training scenario. If no, the control module 120 can continuously check for a target while the training scenario is running.

In a third step, if the control module 120 determines a target is being displayed (e.g., in a frame being displayed), the control module 120 can dim (or lower a brightness) of each LED panel containing a portion of the target.

In a fourth, decision, step, the control module 120 can determine if the target is still being displayed and alter any new LED panels that may contain the target as the target may move from one LED panel to another.

If a fifth step, the control module 120 can brighten each LED panel that may have been dimmed after determining that the target is no longer being displayed.

In a third method (or process), the control module 120 can be configured to alter a saturation of one or more pixels of the LED display assembly such that light having a wavelength close to the laser of the simulated weapon can be eliminated. More specifically, a target can be masked and pixels (e.g., individual LEDs) associated with the masked target can have their color saturated such that the LEDs do not emit light having a wavelength close to the IR light emitted by the laser of the simulated weapon.

In a first step, the control module 120 can initiate the training scenario to be played and displayed via the LED display assembly.

In a second, decision, step, the control module 120 can continuously determine if a target is located in a frame of the training scenario. If no, the control module 120 can continuously check for a target while the training scenario is running.

In a third step, if the control module 120 determines a target is being displayed (e.g., in a frame being displayed), the control module 120 can alter a saturation of each pixel displaying the target. Typically, the alteration in a saturation of a color being displayed can help ensure that light being generated by the LED display assembly is not within the wavelength of the IR laser. This can allow for the simulator system to more accurately determine a shot location to determine if a user hit a target in the training scenario.

In a fourth, decision, step, the control module 120 can determine if the target is still being displayed and alter any new pixels that may contain the target as the target may move from locations in the training scenario.

If a fifth step, the control module 120 can return a pixel to a normal saturation level that may have been altered after determining that the target is no longer being displayed by the pixel.

### An Embodiment of a Mounting System for a Multi-Configuration LED Display Assembly

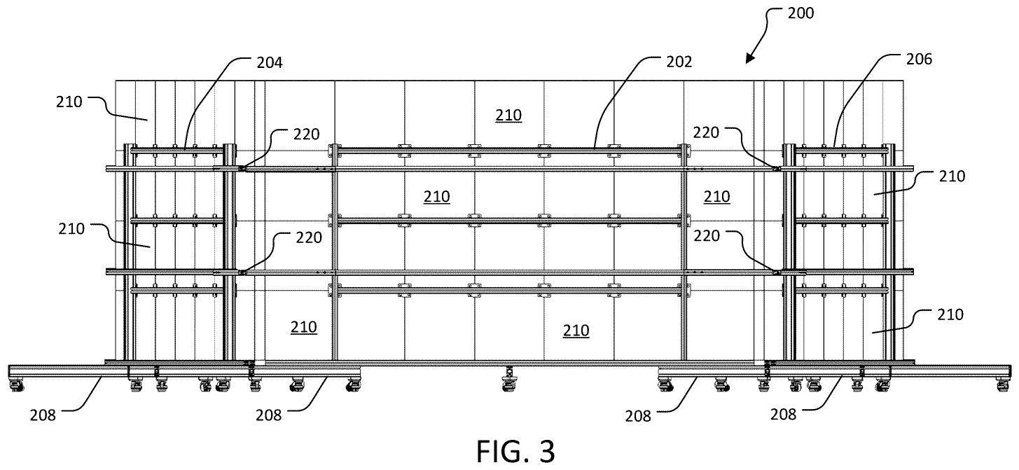

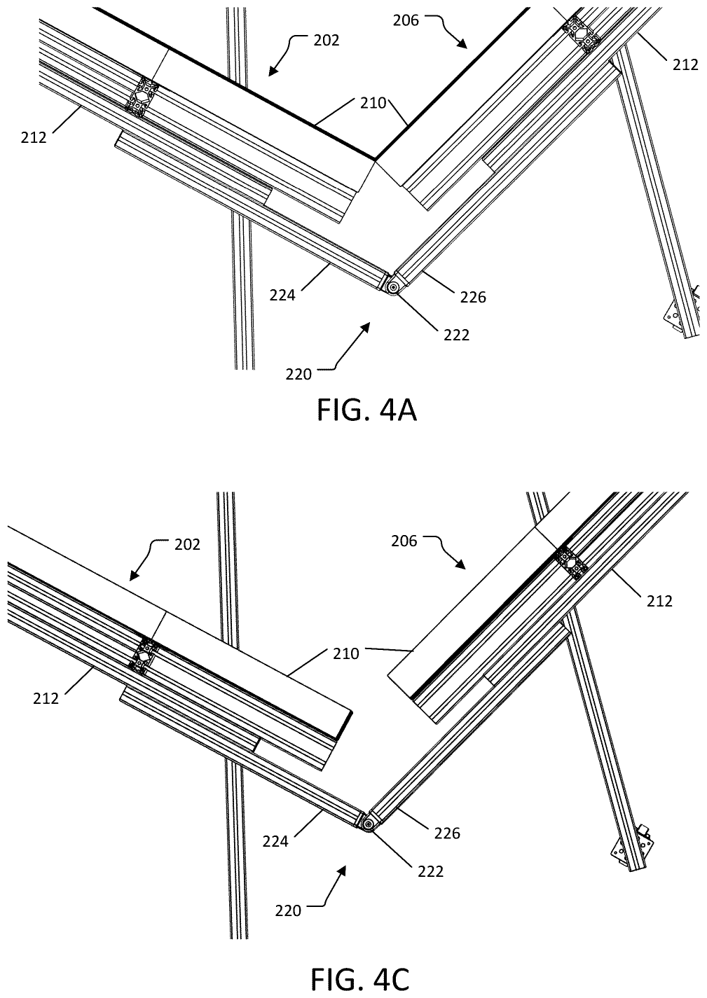

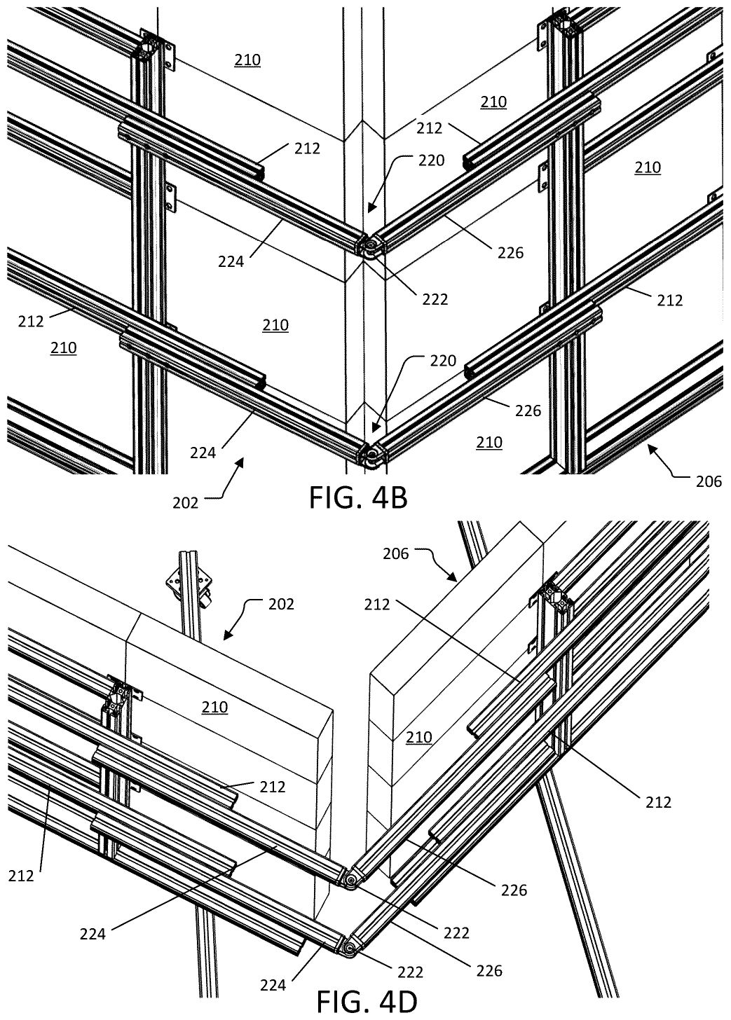

Referring generally to FIGS. 3-4D, detailed diagrams of an embodiment 200 of a mounting system for a multi-configuration LED display assembly similar to the first embodiment assembly 102 are illustrated. FIG. 3 includes a back view of the mounting system 200 including LED panels. FIG. 4A includes a top view of a hinge assembly of the mounting system 200. FIG. 4B includes a back perspective view of a hinge assembly of the mounting system 200. FIG. 4C includes a view similar to FIG. 4A with one frame assembly separated from another frame assembly. FIG. 4D includes a view similar to FIG. 4B with one frame assembly separated from another frame assembly. Of note, the mounting system 200 can be implemented to allow for LED displays to be rotated relative to one another. As can be appreciated, this can allow for various configurations of a multi-display assembly implementing LED panels. The components of the mounting system 200 can typically be made from a lightweight and rigid material.

The mounting system 200 can include, but is not limited to, a first frame assembly 202, a second frame assembly 204, a third frame assembly 206, and a plurality of hinge assemblies 220. In one instance, each of the frame assemblies 202-206 can include one or more base supports 208 having wheels (or casters) to facilitate a rotation of the frame assemblies. As shown, each of the frame assemblies 202-206 can be configured to support a plurality of LED panels 210 forming a display. Of note, the mounting system 200 can be implemented as part of the LED displays 110-114 of the multi-configuration LED display system 100. The plurality of hinge assemblies 220 can be implemented to hingeably couple the frame assemblies 202-206 to one another. For instance, the plurality of hinge assemblies 220 can allow the second frame assembly 204 and the third frame assembly 206 to rotate (or pivot) relative to the first frame assembly 202. As can be appreciated, this can allow for a multi-configuration of the LED displays 110-114.

Of note, LED panels are generally made from non-flexible material. As such, panels of displays located proximate another display would not allow for a rotation of a panel without damaging one or more panels. A novel means of allowing LED panels to be rotated relative to one another is needed. As previously mentioned, the plurality of hinge assemblies 220 can be implemented to allow for LED displays to be rotated relative to one another.

In operation, the plurality of hinge assemblies 220 can allow the second frame assembly 204 and the third frame assembly 206 to be to pulled away from the first frame assembly 202, pivoted (or rotated) to a desired position, and then pushed back towards the first frame assembly 202 to close a gap between LED panels 210 secured to the frame assemblies 202-206. Of significant note, the hinge assemblies 220 can allow for a nearly seamless transition between LED displays in any orientation without damaging the LED panels 210.

As shown generally in FIGS. 4A-4D, the hinge assemblies 220 can each include, but are not limited to, a hinge member 222, a first member 224 extending from the hinge member 222, and a second member 226 extending in an opposite direction from the hinge member 222. In general, the first member 224 and the second member 226 can be rotatably coupled together via the hinge member 222. Each of the frame assemblies 202-206 can include hinge attachment members 212 configured to slidably couple to one the plurality of hinge assemblies 220. Of note, various means for slidably coupling the components are contemplated and not outside a scope of the present invention. In one example, the components can be coupled via interlocking channels that can be tightened together to stop them from sliding.

The first member 224 and the second member 226 can each be configured to slidably couple to one of the hinge attachment members 212 of the frame assemblies 202-206. For instance, for a first hinge assembly located between the first frame assembly 202 and the second frame assembly 204, a hinge attachment member of the first frame assembly 202 can be slidably engaged to the first member of the first hinge assembly and a hinge attachment member of the second frame assembly 204 can be slidably engaged to the second member of the first hinge assembly. Similarly, for a second hinge assembly located between the first frame assembly 202 and the third frame assembly 206, a hinge attachment member of the first frame assembly 202 can be slidably engaged to the first member of the second hinge assembly and a hinge attachment member of the second frame assembly 204 can be slidably engaged to the second member of the second hinge assembly.

As previously mentioned, to rotate the second frame assembly 204 relative to the first frame assembly 202, the second frame assembly 204 can be pulled away from the first frame assembly 204. Once the LED panels 210 are separated such that they will not touch each other when rotated, the hinge members 222 can allow for the frame assemblies 202, 204 to be rotated relative to one another. More specifically, the first member 224 and the second member 226 can each be slid along the hinge attachment members 212 such that the frame assemblies 202, 204 are separated from each other. Of note, the slidably connected components between the frame assemblies 202, 204 and the hinge assemblies 220 can allow for the second frame assembly 204 to be pulled away from the first frame assembly 202 and rotated. As can be appreciated, after the second frame assembly 204 can be in a desired position relative to the first frame assembly 202, the second frame assembly 204 can be pushed back toward the first frame assembly 202 such that the LED panels 210 form a seamless (or nearly seamless) transition. By implementing sliding members, a distance between edges of the LED panels 210 can be adjusted as necessary for each configuration of the multi-configuration LED display assembly 102. Of significant note, the mounting system 200 can help ensure that every orientation configurable between frame assemblies, a nearly seamless transition can be maintained between LED panels 210 of different frame assemblies. In some embodiments, at least two hinge assemblies 220 can be implemented to couple frame assemblies together.

Referring to FIGS. 4C-4D, views similar to FIGS. 4A-4B showing the third frame assembly 206 separated from the first frame assembly 202 are illustrated. FIG. 4C shows the third frame assembly 206 separated from the first frame assembly 202 similar to the view of the third frame assembly 206 located proximate the first frame assembly 202 shown in FIG. 4A. FIG. 4D shows the third frame assembly 206 separated from the first frame assembly 202 similar to the view of the third frame assembly 206 located proximate the first frame assembly 202 shown in FIG. 4B.

As previously mentioned, to rotate the second frame assembly 204 (or the third frame assembly 206) in relation to the first frame assembly 202, the frame assemblies 202-206 first need to be separated from each other. Once the frame assemblies that are being reconfigured are separated, the frame assemblies can be rotated (or pivoted) relative to one another. As shown, the LED panels 210 can be safely rotated relatively to to one another without damaging the LED panels. Once the LED panels 210 are in a predetermined position relative to one another, the associated frame assemblies can be pushed back together such that the LED panels 210 create a nearly seamless transition between adjacent LED panels 210 of different frame assemblies. As can be appreciated, this can ensure that the LED panels 210 are not damaged when being rotated.

### Alternative Embodiments and Variations

The various embodiments and variations thereof, illustrated in the accompanying Figures and/or described above, are merely exemplary and are not meant to limit the scope of the invention. It is to be appreciated that numerous other variations of the invention have been contemplated, as would be obvious to one of ordinary skill in the art, given the benefit of this disclosure. All variations of the invention that read upon appended claims are intended and contemplated to be within the scope of the invention.

We claim:

1. A method of configuring a multi-configuration LED display assembly, the method comprising:
providing a mounting system, the mounting system including:
a first frame assembly coupled to and supporting a first set LED panels;
a second frame assembly coupled to and supporting a second set of LED panels;
a third frame assembly coupled to and supporting a third set of LED panels;
a first hinge assembly hingeably coupling the second frame assembly to the first frame assembly, the first hinge assembly defined by (i) a first hinge member, (ii) a first member extending from the first hinge member in a first direction and slidably coupled to the first frame assembly, and (iii) a second member extending from the first hinge member in a second direction and slidably coupled to the second frame assembly;
a second hinge assembly hingeably coupling the third frame assembly to the first frame assembly, the second hinge assembly defined by (i) a second hinge member, (ii) a third member extending from the second hinge member in a first direction and slidably coupled to the first frame assembly, and (iii) a fourth member extending from the second hinge member in a second direction and slidably coupled to the third frame assembly;
providing a simulator system operatively connected to the first set of LED panels, the second set of LED panels, and the third set of LED panels; and
configuring the second frame assembly in relation to the first screen assembly by: (i) separating the second frame assembly from the first frame assembly via the first hinge assembly; (ii) rotating the second frame assembly in relation to the first frame assembly; and (iii) pushing the second frame assembly back towards the first frame assembly.

2. The method of claim 1, wherein the second frame assembly is separated from the first frame assembly by sliding (i) the first member away from the first frame assembly, and (ii) the second member from the third frame assembly.

3. The method of claim 1, further including the step of:
configuring the third frame assembly in relation to the first screen assembly by: (i) separating the third frame assembly from the first frame assembly via the second hinge assembly; (ii) rotating the third frame assembly in relation to the first frame assembly; and (iii) pushing the third frame assembly back towards the first frame assembly.

4. The method of claim 2, wherein the third frame assembly is separated from the first frame assembly by sliding (i) the third member away from the first frame assembly, and (ii) the fourth member from the third frame assembly.

5. The method of claim 1, wherein the first frame assembly further includes a boom coupled proximate a top of the first frame assembly, the boom extending out from the first set of LED panels with a camera coupled to a distal end of the boom.

6. The method of claim 1, wherein the second frame assembly further includes a boom coupled proximate a top of the second frame assembly, the boom extending out from the second set of LED panels with a camera coupled to a distal end of the boom.

7. The method of claim 1, wherein the third frame assembly further includes a boom coupled proximate a top of the third frame assembly, the boom extending out from the third set of LED panels with a camera coupled to a distal end of the boom.

8. The method of claim 7, wherein the camera has a 96-degree field of view.

9. The method of claim 8, wherein the camera is operatively connected to the simulator system.
